(19) United States
(12) Patent Application Publication
(10) Pub. No.: US 2008/0079629 A1
(43) Pub. Date: Apr. 3, 2008

(54) Obstacle detecting apparatus and method of vehicle

(75) Inventors: Takuji Oka, Hiroshima (JP); Hiroshi Ohmura, Hiroshima (JP); Haruki Okazaki, Hiroshima (JP); Sei Kobayashi, Hiroshima (JP); Takashi Nakagami, Hiroshima (JP); Takayuki Seto, Hiroshima (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION

(21) Appl. No.: 11/892,689

(22) Filed: Aug. 27, 2007

(30) Foreign Application Priority Data
Sep. 28, 2006 (JP) 2006-265231

(51) Int. Cl. G01S 13/32

(52) U.S. Cl. 342/128

(57) ABSTRACT

There are provided a radar device that transmits a frequency modulation-continuous wave (FM-CW) and outputs an up-beat frequency and a down-beat frequency, a pairing processing section that conducts pairing of the up-beat frequency and the down-beat frequency at specified sampling intervals, a target-object detecting section that detects target objects around the vehicle, obtaining a distance from the vehicle to the target object and a relative speed between the vehicle and the target object based on the up-beat frequency and down-beat frequency that are paired, and a prediction processing section that obtains a prediction data for each target object for a next sampling timing. The pairing processing section conducts the pairing with priority to a specified target object that has a high certainty of the prediction data. Thereby, the pairing of the up-beat and down-beat frequencies can be conducted precisely and quickly.

### BACKGROUND OF THE INVENTION

The present invention relates to an obstacle detecting apparatus and method of a vehicle that detects an obstacle in front of the vehicle, and more specifically, relates to an obstacle detecting apparatus and method of a vehicle that uses a radar of a frequency modulation-continuous wave (FM-CW).

Recently, various types of obstacle detecting apparatus that detects the obstacle in front of the vehicle have been proposed for a vehicle traveling control or a vehicle safe traveling with a collision prediction or the like. According to the obstacle detecting apparatus, the radar transmits the millimeter-wave forward to detect the obstacle in front, for example, and receives its reflecting wave. Generally, the radar device of the frequency modulation-continuous wave (FM-CW) has been well used because of its properly light and compact structure (see Japanese Patent Laid-Open Publication No. 2004-198438, for example).

The above-described FM-CW radar transmits the frequency modulation-continuous wave and outputs an up-beat frequency and a down-beat frequency. Herein, the up-beat frequency is a difference between a transmitting frequency and a receiving frequency in a going-up section of the transmitting frequency by a frequency modulation. The down-beat frequency is a difference between the transmitting frequency and the receiving frequency in a going-down section of the transmitting frequency by the frequency modulation. The location of the target object or the relative speed between the vehicle and the target object can be obtained based on these up-beat frequency and the down-beat frequency.

Herein, in a case where there exist a plurality of target objects, the radar output contains the up-beat frequencies and the down-beat frequencies that correspond to the plural target objects, respectively. Hence, the pairing (selection) of the both frequencies for each target object may be necessary to be conducted by selecting a specified up-beat frequency and a specified down-beat frequency that correspond to the specified target object.

When the obstacles in front of the vehicle are detected, many target objects thereof are detected at the same time. And, even if the target objects are stationary, the relative location of these objects from the vehicle or the like may change in accordance with the traveling (proceeding) of the vehicle. Thus, the obstacle detecting apparatus of a vehicle needs to conduct a correct pairing (selection) of its correspondent up-beat frequency and down-beat frequency to each target object in a very short time at each sampling timing.

In the conventional obstacle detecting apparatus of a vehicle using the FM-CW radar, the pairing of the up-beat frequency and the down-beat frequency was conducted to all of target objects uniformly.

Accordingly, there occurred a case in which the pairing of the up-beat frequency and the down-beat frequency was conduced even to some particular target objects, such as a so-called ghost, that might not be detected for the next sampling timing, before conducting the pairing to the target object that had a high certainty of its detection at the predicted location. As a result, the inappropriate pairing was conducted in advance, so the necessary pairing to the target object having the high certainty of its detection at the predicted location could not conducted surely. And, in the event that this inappropriate pairing happed, for example, all of the pairing of the up-beat frequency and the down-beat frequency were restarted (tried again).

### SUMMARY OF THE INVENTION

The present invention has been devised in view of the above-described problem, and an object of the present invention is to provide an obstacle detecting apparatus and method of a vehicle that can conduct the pairing of the up-beat frequency and the down-beat frequency precisely and quickly.

According to the present invention, there is provided an obstacle detecting apparatus of a vehicle, comprising a radar device to transmit a frequency modulation-continuous wave and output an up-beat frequency and a down-beat frequency, the up-beat frequency being a difference between a transmitting frequency and a receiving frequency in a going-up section of the transmitting frequency by a frequency modulation, the down-beat frequency being a difference between the transmitting frequency and the receiving frequency in a going-down section of the transmitting frequency by the frequency modulation, a pairing device to conduct pairing of the up-beat frequency and the down-beat frequency at specified sampling intervals, a target-object detecting device to detect target objects around the vehicle, obtaining a distance from the vehicle to the target object and a relative speed between the vehicle and the target object based on the up-beat frequency and the down-beat frequency that are paired, and a predicting device to obtain a prediction data for each target object for a next sampling timing, wherein the pairing device is configured to conduct the pairing with priority to a specified target object that has a high certainty of the prediction data obtained by the predicting device. Thereby, the pairing is conducted with priority to the specified target object that has the high certainty of the prediction data. Accordingly, the pairing of the up-beat frequency and the down-beat frequency can be conducted precisely and quickly.

According to an embodiment of the present invention, the pairing device is configured to divide the target objects into a high class in which the target object has a relatively high certainty of the prediction data and a low class in which the target object has a relatively low certainty of the prediction data, conduct the pairing to the target object in the high class first, and then conduct the pairing to the target object in the low class by selecting the up-beat frequency and the down-beat frequency that are not paired yet. Thereby, in the event that the inappropriate pairing to the target object in the low class happens after the pairing to the target object in the high class has been conducted, only the pairing to the target object in the low class can be restarted. Namely, it may not be necessary to conduct the pairing to the target object in the high class again. Accordingly, the time for the pairing can be shortened properly.

According to another embodiment of the present invention, the pairing device is configured to divide the target objects into classes based on the number of sampling in which the target object that is actually detected substantially corresponds to the prediction data. Thereby, the classification of target objects can be done easily by using the correspondence number.

According to another embodiment of the present invention, the pairing device is configured to conduct the pairing to the target objects having the prediction data by selecting the up-beat frequency and the down-beat frequency that provide the highest correspondence of the target object to the prediction data. Thereby, the pairing of the target object having the prediction data can be conducted precisely.

According to another embodiment of the present invention, the prediction data obtained by the predicting device includes a distance from the vehicle to the target object and a relative speed between the vehicle and the target object for the next sampling timing. Thereby, the degree of correspondence of the pairing of the up-beat frequency and the down-beat frequency to the prediction data of the target object can be evaluated based on the distance and the relative speed of the target object.

According to another embodiment of the present invention, the pairing device is configured to conduct the pairing to the target object having the prediction data first and then conduct the pairing to a new target object by selecting the up-beat frequency and down-beat frequency that are not paired yet. Thereby, in the event that the inappropriate pairing to the new target object happens after the pairing to the target object having the prediction data has been conducted, it may not be necessary to conduct the pairing to the target object having the prediction data again. Accordingly, the time for the pairing can be shortened properly.

According to another embodiment of the present invention, the pairing device is configured to conduct the pairing to the new target object based on a receiving direction and a receiving intensity of respective receiving waves of the up-beat frequency and the down-beat frequency. Thereby, the pairing of the up-beat frequency and the down-beat frequency that are not paired yet can be conducted even to the new target object that has no prediction data.

According to the present invention, there is provided an obstacle detecting method of a vehicle, comprising the steps of transmitting a frequency modulation-continuous wave and obtaining an up-beat frequency and a down-beat frequency, the up-beat frequency being a difference between a transmitting frequency and a receiving frequency in a going-up section of the transmitting frequency by a frequency modulation, the downbeat frequency being a difference between the transmitting frequency and the receiving frequency in a going-down section of the transmitting frequency by the frequency modulation, conducting pairing of the up-beat frequency and the down-beat frequency at specified sampling intervals, detecting target objects around the vehicle, by obtaining a distance from the vehicle to the target object and a relative speed between the vehicle and the target object based on the up-beat frequency and down-beat frequency that are paired, and obtaining a prediction data for each target object for a next sampling timing, wherein the pairing conducted is configured to be done by conducting the pairing with priority to a specified target object that has a high certainty of the prediction data obtained.

Other features, aspects, and advantages of the present invention will become apparent from the following description which refers to the accompanying drawings.

### BRIEF DESCRIPTION OF THE DRAWINGS

FIG. 1 is a block diagram of an obstacle detecting device of a vehicle according to an embodiment of the present invention.

FIG. 2A is a graph showing a transmitting wave and a receiving wave of a radar device, and FIG. 2B is a graph showing beat waves.

FIG. 3A is a graph showing a transmitting wave and receiving waves of a plurality of target objects, FIG. 3B, is a graph showing results of Fourier transformation of a beat wave in a going-up section of a transmitting frequency, and FIG. 3C is a graph showing results of Fourier transformation of a beat wave in a going-down section of the transmitting frequency.

FIG. 4 is a flowchart of processing of a pairing processing section.

FIG. 5 is a flowchart of detailed pairing processing.

FIG. 6A is sampling data schematically shown, and FIG. 6B is prediction data schematically shown.

FIG. 7 is data of up-beat frequencies and down-beat frequencies of a target object in a high certainty class, a target object in a low certainty class, and a new target object, which are to be paired at pairing processing stages.

FIG. 8 is a flowchart of detailed pairing processing.

FIG. 9 is a flowchart of detailed pairing processing.

### DETAILED DESCRIPTION OF THE INVENTION

Hereinafter, a preferred embodiment of an obstacle detecting device and method of a vehicle according to the present invention will be descried referring to the accompanying drawings.

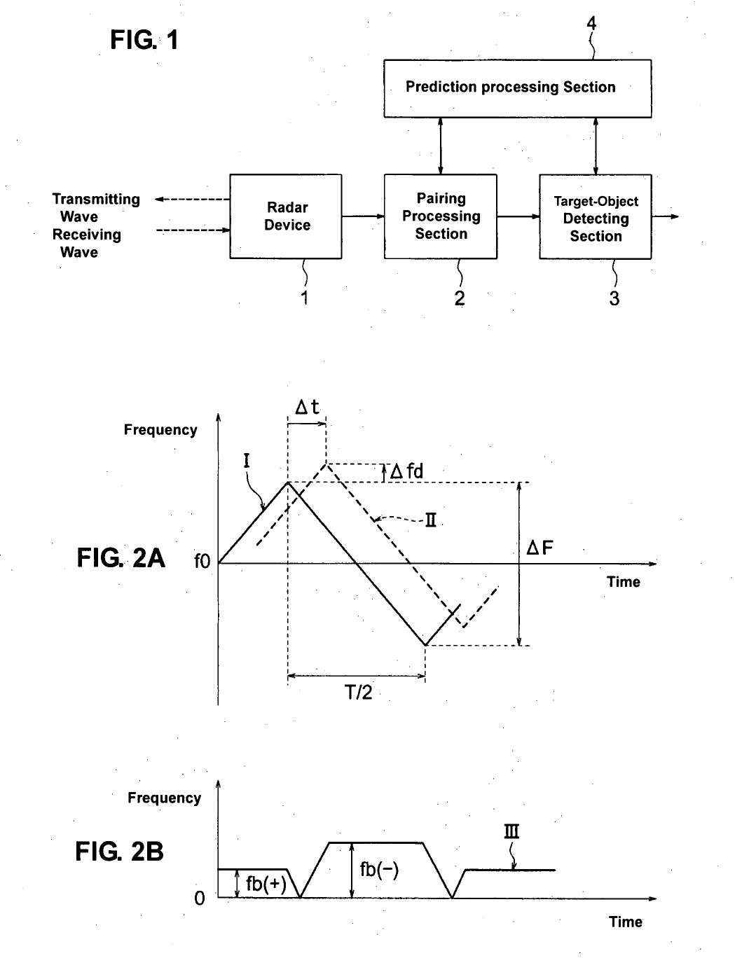

First, the obstacle detecting apparatus of a vehicle of the present embodiment will be described referring to a block diagram of FIG. 1. The obstacle detecting apparatus comprises, as shown in FIG. 1, a radar device 1, a pairing processing section 2 that conducts pairing of an up-beat frequency and a down-beat frequency at specified sampling intervals, a target-object detecting section 3 that detects target objects around the vehicle, obtaining a distance from the vehicle to the target object and a relative speed between the vehicle and the target object based on the up-beat frequency and down-beat frequency that are paired, a prediction processing section 4 that obtains a prediction data for each target object for a next sampling timing.

Herein, respective functions of the above-described pairing processing section 2, target-object detecting section 3 and prediction processing section 4 can be carried out by an IC tip or computer programs executed by a computer, for example. The above-described specified sampling intervals means an interval of a sampling time of the radar device 1, which is 100 milliseconds, for example.

The radar device 1 transmits a frequency modulation-continuous wave (FM-CM) of a millimeter wave and outputs the up-beat frequency and the down-beat frequency.

FIG. 2A shows a graph of a transmitting wave and a receiving wave of the radar device 1. The axis of abscissas of the graph indicates the time, and the axis of ordinates of the graph indicates the frequency. The frequency of the transmitting wave oscillates, repeating its going-up and going-down movement, with a center frequency f0 and a half frequency T/2 within an amplitude of frequency modulation ΔF, as shown by a solid line I in FIG. 2A. As shown by a broken line II in FIG. 2A, the frequency of the receiving wave is also modulated like the transmitting wave.

Herein, the receiving wave may be delayed from the transmitting wave by a delay time Δt that depends on a distance from the vehicle to a target object that reflects the transmitting wave. And, the frequency of the receiving wave may be shifted from the frequency of the transmitting wave by a Doppler shift Δfd that depends on the relative speed between the vehicle and the target object. When the target object is approaching the vehicle, the frequency of the receiving wave becomes higher than that of the transmitting wave. Thereby, there exists a frequency difference between the transmitting wave and the receiving wave as shown by the solid line I and the broken line II.

FIG. 2B shows an up-beat frequency fb(+) and a down-beat frequency fb(−). The axis of abscissas of the graph indicates the time, and the axis of ordinates of the graph indicates the frequency. The up-beat frequency is a difference between the transmitting frequency and the receiving frequency in a going-up section of the transmitting frequency by the frequency modulation. The down-beat frequency is a difference between the transmitting frequency and the receiving frequency in a going-down section of the transmitting frequency by the frequency modulation. In an example shown by a line III in FIG. 2B, the down-beat frequency is higher than the up-beat frequency. This corresponds to a case where the target object is approaching.

The distance R from the vehicle to the target object may be obtained by the up-beat frequency fb(+) and the down-beat frequency fb(−) based on the following equation (1).

R={fb(+)+fb(−)}·C/·(8T·ΔF) (1)

Herein, C indicates the velocity of light. T and ΔF indicate the frequency of frequency modulation and the amplitude of frequency modulation, respectively, as shown in FIG. 2A.

The relative speed V between the vehicle and the target object may be obtained by the up-beat frequency fb(+) and the down-beat frequency fb(−) based on the following equation (2).

V={fb(−)−fb(+)}·C/(4·f0) (2)

Herein, f0 indicates the center frequency of frequency modulation as shown in FIG. 2A.

When the radar device 1 transmits the millimeter wave forward, the transmitting wave is reflected by various target objects. Not only vehicles that travel in front of the vehicle or travel in the opposite lane toward the vehicle but some guide rails, electric poles and the like may reflect the transmitting wave. Accordingly, the radar device 1 may receive reflected waves from various objects at the same time.

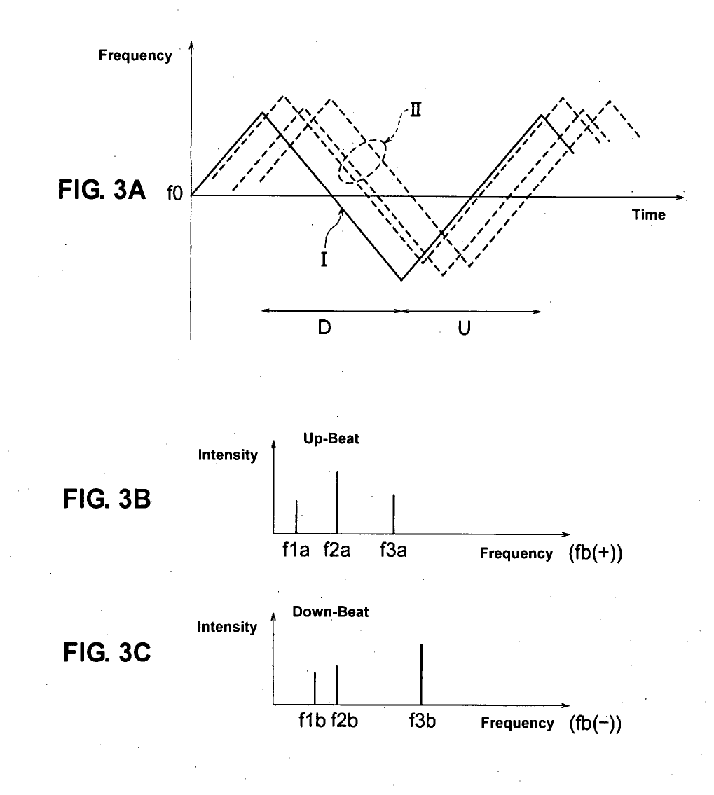

A graph of FIG. 3A shows the transmitting wave and the receiving waves of a plurality of target objects. The axis of abscissas of the graph indicates the time, and the axis of ordinates of the graph indicates the frequency. A plurality of reflected waves return as shown by the broken line II with respect to a single transmitting shown by the solid line I in FIG. 3A. In FIG. 3A, the reflected waves returning from different objects are shown separately just for convenience. Actually, these may be overlapped, so the plural reflected waves may show irregular and complex shapes. Hence, respective waves of the up-beat frequency and the down-beat frequency in FIG. 2B may show irregular shapes actually.

Herein, in order to separate the up-beat frequency and the down-beat frequency for each target object, the Fourier transformation is conducted to the waves of these frequencies.

A graph of FIG. 3B schematically shows results of the Fourier transformation of a beat wave in the going-up section U of the transmitting frequency. A graph of FIG. 3C schematically shows results of the Fourier transformation of a beat wave in a going-down section D of the transmitting frequency. Each axis of abscissas of these graphs indicates the frequency, and each axis of ordinates of these graphs indicates an intensity. In an example shown in FIG. 3B, three up-beat frequencies f1a, f2a, f3a are outputted. In an example shown in FIG. 3C, three down-beat frequencies f1b, f2b, f3b are outputted.

In order to calculate the distance and the relative speed for each target object, it is necessary to select and pair the up-beat frequency and the down-beat frequency for each target object. For example, by selecting the one among the three up-beat frequencies f1a, f2a, f3a of FIG. 3B and the one among three down-beat frequencies f1b, f2b, f3b of FIG. 3C, respectively, it may be necessary to make three pairs of pairing (selection).

Herein, the pairing processing section 2 conducts the pairing of the up-beat frequency and the down-beat frequency with priority to a specified target object that has a high certainty of the prediction data obtained by the prediction processing section 4.

In order to do so, the pairing processing section 2 of the present embodiment is configured to divide the target objects into a high class in which the target object has a relatively high certainty of the prediction data and a low class in which the target object has a relatively low certainty of the prediction data as a premise of its pairing processing. Specifically, this classification is done based on the number of sampling in which the target object that is actually detected substantially corresponds to the prediction data. Herein, the target object that has three times or more of its correspondence sampling number is considered as the one in the high certainty class, while the target object that has twice or less of its correspondence sampling number is considered as the one in the low certainty class, for example.

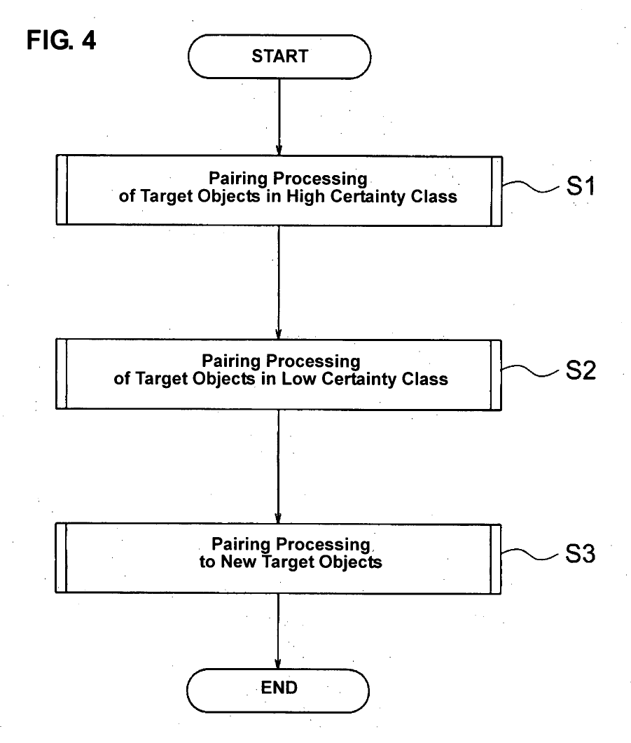

As shown in a flowchart of FIG. 4, the pairing processing is conducted to the target objects in the high certainty class (step S1) first. Then, the pairing processing is conducted to the target objects in the low certainty class (step S2). Finally, the pairing processing is conducted to the new target objects (step S3).

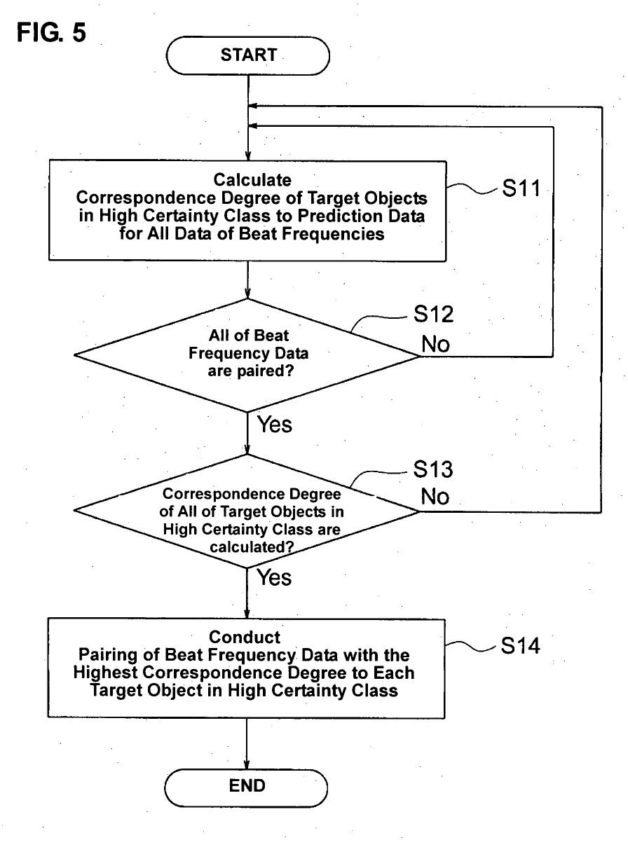

Hereinafter, the specific pairing processing to the target objects in the high certainty class of the step S1 of FIG. 4 will be described referring to a flowchart of FIG. 5. First, a degree of the correspondence of the target objects in the high certainty class to the prediction data is calculated for all data of the beat frequencies that are stored in a memory (step S11).

In the present embodiment, this correspondence degree is Calculated by an evaluation function ε shown by the following equation (3). This evaluation function ε has parameters of receiving power P, beat frequency F, receiving angle (direction) Θ, distance R to the target object, relative speed V of the target object as follows. And, a difference between the data at the present sampling timing (sampling data) and the prediction data is obtained for each parameter, and formalization and weighting are conducted for each parameter.

ε=Ap(PUPn−PUPm)/Pmax+Ap(PDWn−PDWm)/Pmax+Af(FUPn−FUPm)/Fmax+Af(PDWn−PDWm)/Fmax+Aθ(Θn−Θm)/Θmax+Ar(Rn−Rm)/Rmax+Av(Vn−Vm)/Vmax (3)

Herein, n indicates the prediction data based on data at the previous sampling timings or the data at the previous sampling timing, and m indicates the data at the present sampling timing (sampling data).

Further, PUP indicates the receiving power of the up-beat frequency, and PDW indicates the receiving power of the down-beat frequency. FUP indicates the up-beat frequency, and FDW indicates the down-beat frequency. Θ indicates the receiving angle (direction), R indicates the distance, and V indicates the relative speed.

Also, A indicates a parameter of a load. Thus, Ap indicates the weighting of the receiving power, Af indicates the weighting of the beat frequency, Aθ indicates the weighting of the receiving angle, Ar indicates the weighting of the distance, and Av indicates the weighting of the speed.

Herein, the parameters of the distance and the relative speed of the target object in the high certainty class are sufficiently predictable. Therefore, it may be preferable that the distance and the relative speed be weighted for the pairing with respect to the target object in the high certainty class. For example, it may be preferable to set that Ap=Af=Aθ=0.5 and Ar=Av=1.0.

Moreover, Pmax, Fmax, Θmax, Rmax and Vmax indicate parameters for formalization, respectively. These are values for formalizing the weights of the parameters forming the evaluation function ε, which show the maximum value of the respective parameters. Herein, the formalization parameters may be included in the load parameters A.

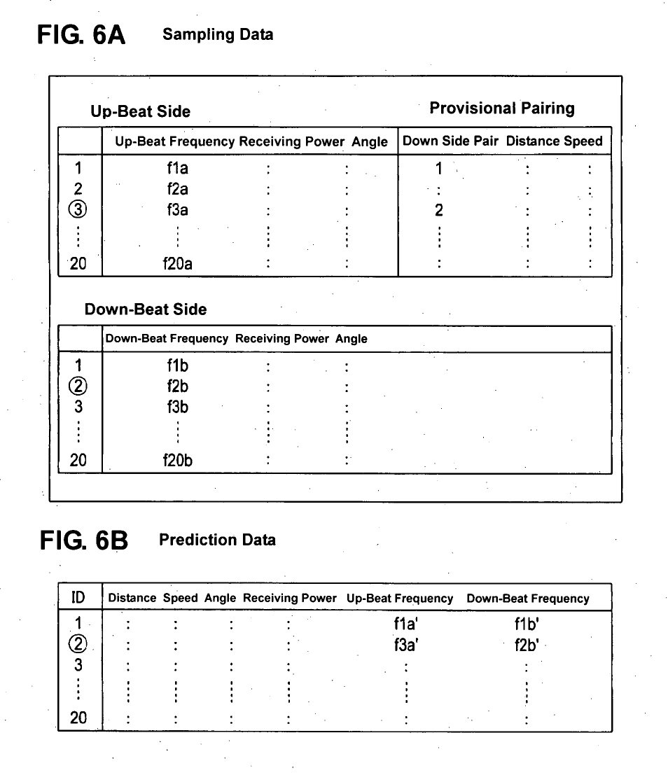

FIG. 6A shows the sampling data and FIG. 6B shows the prediction data that are to be used as the parameter of the evaluation function ε. These data is stored in the memory not illustrated. Although the memory is not shown in FIG. 1, there may be provided a memory device that is different from the block shown in FIG. 1, or this memory may be provided in the block.

The sampling data is comprised of data on the up-beat side shown at the top of FIG. 6A and data on the down-beat side shown at the bottom of FIG. 6A. The up-beat-side data comprises up-beat frequencies f1a-f20a of Nos. 1-20. The down-beat-side data comprises down-beat frequencies f1b-f20b of Nos. 1-20. For each of the up-beat frequencies (f1a-f20a) and the down-beat frequencies (f1b-f20b), the “receiving power” and the “angle” are stored.

The prediction data includes the “distance”, “speed”, “angle”, “receiving power”, “up-beat frequency” and “down-beat frequency” for each of the target objects (ID1-ID20) as shown in FIG. 6B. A portion of indication of the value data of the respective parameters is omitted in FIGS. 6A, 6B.

For the above-described “distance” and “speed” of the prediction data shown in FIG. 6B, the distance from the vehicle to the target object and the relative speed between the vehicle and the target object that are obtained by the calculation based on the beat frequencies at the previous sampling timing may be preferably used. Also, for the “angle” and “receiving power” of the prediction data, the values at the previous sampling timing or values that are predicted from these values may be used. For the “up-beat frequency” and “down-beat frequency” of the prediction data, the values that are obtained by calculation based on the distance and the speed may be used or the up-beat frequency and the down-beat frequency at the previous sampling timing may be stored and used.

In case of conducting the pairing to the target objects in the high certainty class, the evaluation function ε is calculated for pairing of all of the up-beat and down-beat-frequencies that are obtained from the Fourier transformation (step S12 of FIG. 5).

For the sampling data shown in FIG. 6A, provisional pairing of each of the up-beat frequencies f1a-f20a of Nos. 1-20 to all of the down-beat frequencies f1b-f20b of Nos. 1-20 is conducted in order. Thereby, the pairing among all of the beat frequencies can be conducted with priority to the target objects in the high certainty class.

Herein, when the provisional pairing is conducted, the frequencies may be paired in order from the one of No. 1, or the pairing of the up-beat and down-beat frequencies that have similar values of the receiving power and the angle may be conducted with priority.

Then, the correspondence degree of the prediction data and the sampling data for the all target objects in the high certainty class is calculated as described above (step S13 of FIG. 5). In a case where the four target objects (ID1-ID4) among the twenty target objects (ID1-ID20) that have the prediction data shown in FIG. 6B are in the high certainty class, the calculation of the correspondence degree is conducted to these four target objects.

Subsequently, the pairing (selection) of the up-beat frequency data and the down-beat frequency data in which the correspondence degree is the highest is conducted to each of the four target objects in the high certainty class (ID1-ID4) (step S14 of FIG. 5). In the example shown in FIGS. 6A, 6B, for example, the pairing of the prediction data of the target object ID2 that provides the highest correspondence degree is the beat frequencies of the up-beat frequency f3a of No. 3 and the down-beat frequency f2b of No. 2.

Herein, the pairing in which the correspondence degree of the prediction data of the target object is the highest is the one that provides the minimum value of the evaluation function ε as described. In a case where the value of the evaluation function ε is a specified value or greater, it is considered that the pairing of the beat frequencies with respect to its target object has not detected at this sampling timing.

Next, after the pairing to the target objects in the high certainty class is complete, the pairing processing is conducted to the target objects in the low certainty class by selecting the rest of the up-beat and down-beat frequencies that are not paired (the step S2 of FIG. 4).

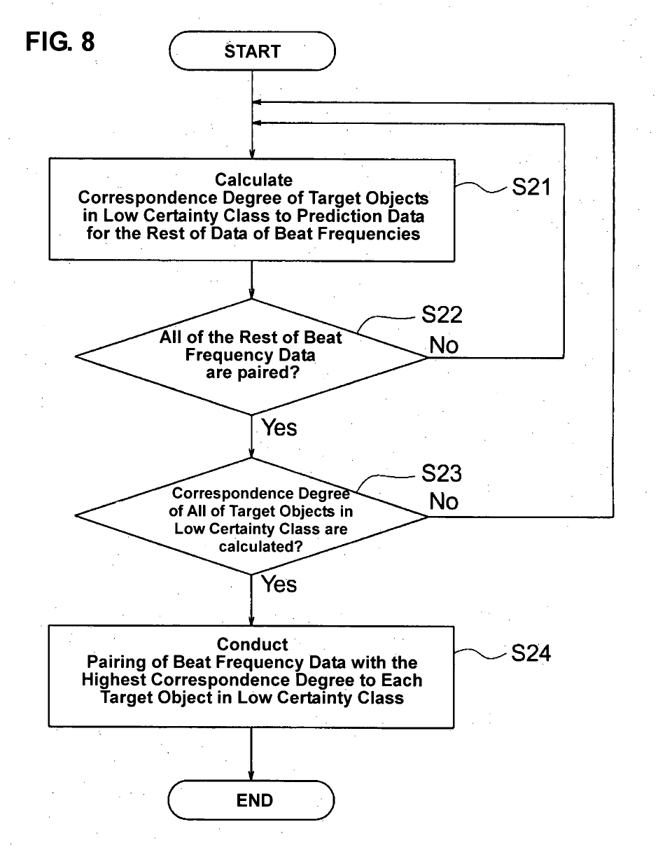

The pairing processing to the target objects in the low certainty class of the step S2 of FIG. 4 will be described referring to a flowchart of FIG. 8. At first, the correspondence degree of the target objects in the high certainty class is calculated for all data of the beat frequencies that are stored in the memory (step S21 of FIG. 8).

The correspondence degree of the target objects in the low certainty class is also calculated by the evaluation function ε of the above-described equation (3). Herein, the correspondence number of the prediction data regarding the target objects in the low certainty class is rather low and the parameters of the distance and the relative speed of these target objects are not sufficiently predictable, so there is little difference in reliability among the parameters. Therefore, it may be preferable that each parameter with respect to the target objects in the low certainty class have the same weighting. For example, it may be preferable to set that Ap=Af=Aθ=Ar=Av=1.0.

In case of conducting the pairing to the target objects in the low certainty class, the evaluation function ε is calculated for pairing of the rest of the up-beat and downbeat frequencies that are obtained from the Fourier transformation but do not correspond to the target objects in the high certainty class (step S22 of FIG. 8).

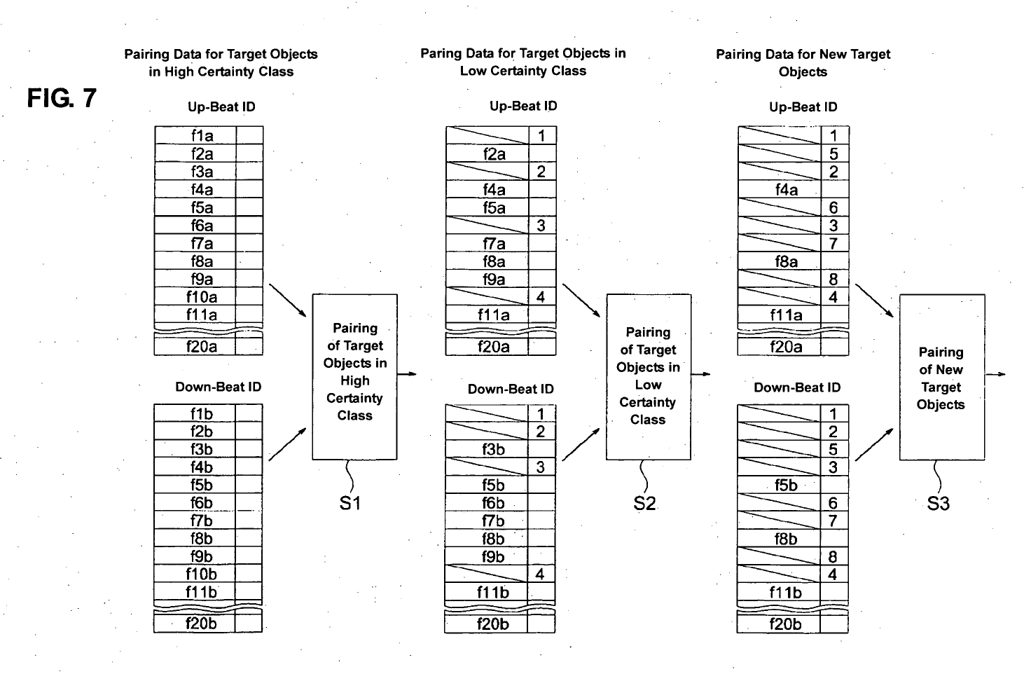

FIG. 7 shows an example of the up-beat frequencies and down-beat frequencies of the target objects in the high certainty class, the target objects in the low certainty class, and the new target objects, which are to be paired at pairing processing stages. A content of the memory that stores the data of the up-beat frequencies (f1a-f20a) and the down-beat frequencies (f1b-f20b) with respect to the target objects in the high certainty class is schematically shown at the left of FIG. 7. All of these data are to be paired for the target objects in the high certainty class.

A content of the memory that stores the data of the up-beat frequencies and the down-beat frequencies with respect to the target objects in the low certainty class is schematically shown at the center of FIG. 7. In this example shown in FIG. 7, the data of the up-beat frequencies f1a, f3a, f6a, f10a and the down-beat frequencies f1b, f2b, f4b, f10b that are selected through the pairing for the target objects in the high certainty class are excluded for the data to be paired for the target objects in the low certainty class.

Then, the correspondence degree of the prediction data and the sampling data for the target objects in the low certainty class is calculated as descried above (step S23 of FIG. 8). If the four target objects (ID5-ID8) are the ones in the low certainty class among the twenty target objects (ID1-ID20) having the prediction data shown in FIG. 6B, the calculation of the correspondence degree is conducted to these four target objects.

Next, the pairing (selection) of the up-beat and down-beat frequencies in which the correspondence degree is the highest is conducted to each of the four target objects (ID5-ID8) in the low certainty class (step S24 of FIG. 8). Herein, the pairing in which the correspondence degree of the prediction data of the target object is the highest is the one that provides the minimum value of the evaluation function ε as described. In a case where the value of the evaluation function ε is a specified value or greater, it is considered that the pairing of the beat frequencies with respect to its target object has not detected at this sampling timing.

Next, after the pairing to the target objects in the high certainty class and the target objects in the low certainty class is complete, the pairing processing is conducted to the new target objects by selecting the rest of the up-beat and down-beat frequencies that are not paired (the step S3 of FIG. 4).

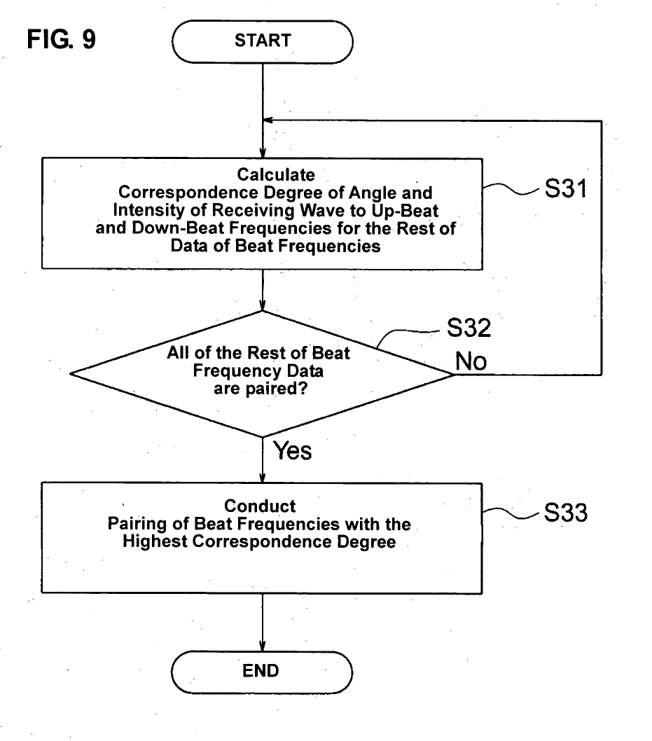

The pairing processing of the new target objects of the step S3 of FIG. 4 will be described referring to a flowchart of FIG. 9.

There is no prediction data that corresponds for the pairing of the new target objects. Therefore, the pairing based on the continuity of the prediction data cannot be conducted. Thus, in the present embodiment, the pairing of the new target objects is conducted based on the receiving direction (receiving angle) and the intensity (receiving power) of the receiving waves of the up-beat frequency and the down-beat frequency (step S31 of FIG. 9). Namely, the pairing of the beat frequencies that have the highest correspondence degree with respect to the receiving angle and the receiving power is conducted (selected), and then indication numbers (ID number) for the new target objects are applied to these.

In case of conducting the pairing to the new target objects, the correspondence degree of the receiving angle and the receiving power is calculated for pairing of the rest of the up-beat and down-beat frequencies that are obtained from the Fourier transformation but do not correspond to the target objects in the high certainty and the low certainty class. (step S32 of FIG. 9).

The calculation of the correspondence degree in this step may be the sum of a weighted difference between the receiving angle of the up-beat frequency and the receiving angle of the down-beat frequency and a weighted difference between the receiving power of the up-beat frequency and the receiving power of the down-beat frequency.

A content of the memory that stores the data of the up-beat frequencies and the down-beat frequencies with respect to the new target objects is schematically shown at the right of FIG. 7. In this example shown in FIG. 7, the data of the up-beat frequencies f1a-f3a, f5a-f7a, f9a, f10a and the down-beat frequencies f1b-f4b, f6b, f7b, f9b, f10b that are selected through the pairing for the target objects in the high certainty class and the target objects in the low certainty class are excluded for the data to be paired for the new target objects.

Then, the correspondence degree of the receiving angle and the receiving power with respect to the rest of the pairing of the up-beat frequency and the down-beat frequency is calculated (step S32 of FIG. 9).

Next, the pairing (selection) of the up-beat and down-beat frequencies in which the correspondence degree is the highest is conducted (step S33 of FIG. 9). Herein, in a case where the correspondence degree is a specified value or greater, it is considered that the pairing of the beat frequencies with respect to its target object has not detected at this sampling timing.

Thereby, the target-object detecting section 3 calculates the distance and the relative speed of the target objects based on the pairing information by the pairing processing section 2. The calculated distance and relative speed become the distance and relative speed of the target object ID2 at the present sampling timing. The prediction processing section 4 calculates the prediction data of the target objects for the next sampling timing based on the information obtained by the pairing processing section 2 and the target-object detecting section 3.

The present invention should not be limited to the above-described embodiments, but any other modifications and improvements of the present invention can be applied. For example, the target objects having the prediction data may be divided into three classes instead of the above-described case in which there are provided two classes of the high and low certainty classes.

What is claimed is:

1. An obstacle detecting apparatus of a vehicle, comprising:
a radar device to transmit a frequency modulation-continuous wave and output an up-beat frequency and a down-beat frequency, the up-beat frequency being a difference between a transmitting frequency and a receiving frequency in a going-up section of the transmitting frequency by a frequency modulation, the down-beat frequency being a difference between the transmitting frequency and the receiving frequency in a going-down section of the transmitting frequency by the frequency modulation;
a pairing device to conduct pairing of the up-beat frequency and the down-beat frequency at specified sampling intervals;
a target-object detecting device to detect target objects around the vehicle, obtaining a distance from the vehicle to the target object and a relative speed between the vehicle and the target object based on the up-beat frequency and the down-beat frequency that are paired; and
a predicting device to obtain a prediction data for each target object for a next sampling timing,
wherein said pairing device is configured to conduct the pairing with priority to a specified target object that has a high certainty of the prediction data obtained by said predicting device.

2. The obstacle detecting apparatus of a vehicle of claim 1, wherein said pairing device is configured to divide the target objects into a high class in which the target object has a relatively high certainty of the prediction data and a low class in which the target object has a relatively low certainty of the prediction data, conduct the pairing to the target object in said high class first, and then conduct the pairing to the target object in said low class by selecting the up-beat frequency and the down-beat frequency that are not paired yet.

3. The obstacle detecting apparatus of a vehicle of claim 1, wherein said pairing device is configured to divide the target objects into classes based on the number of sampling in which the target object that is actually detected substantially corresponds to the prediction data.

4. The obstacle detecting apparatus of a vehicle of claim 1, wherein said pairing device is configured to conduct the pairing to the target objects having the prediction data by selecting the up-beat frequency and the down-beat frequency that provide the highest correspondence of the target object to the prediction data.

5. The obstacle detecting apparatus of a vehicle of claim 1, wherein the prediction data obtained by said predicting device includes a distance from the vehicle to the target object and a relative speed between the vehicle and the target object for the next sampling timing.

6. The obstacle detecting apparatus of a vehicle of claim 1, wherein said pairing device is configured to conduct the pairing to the target object having the prediction data first and then conduct the pairing to a new target object by selecting the up-beat frequency and down-beat frequency that are not paired yet.

7. The obstacle detecting apparatus of a vehicle of claim 6, wherein said pairing device is configured to conduct the pairing to the new target object based on a receiving direction and a receiving intensity of respective receiving waves of the up-beat frequency and the down-beat frequency.

8. An obstacle detecting method of a vehicle, comprising the steps of:
transmitting a frequency modulation-continuous wave and obtaining an up-beat frequency and a down-beat frequency, the up-beat frequency being a difference between a transmitting frequency and a receiving frequency in a going-up section of the transmitting frequency by a frequency modulation, the down-beat frequency being a difference between the transmitting frequency and the receiving frequency in a going-down section of the transmitting frequency by the frequency modulation;
conducting pairing of the up-beat frequency and the down-beat frequency at specified sampling intervals;
detecting target objects around the vehicle, by obtaining a distance from the vehicle to the target object and a relative speed between the vehicle and the target object based on the up-beat frequency and down-beat frequency that are paired; and
obtaining a prediction data for each target object for a next sampling timing,
wherein said pairing conducted is configured to be done by conducting the pairing with priority to a specified target object that has a high certainty of the prediction data obtained.
